(19) United States
(12) Patent Application Publication
(10) Pub. No.: US 2002/0177462 A1
(43) Pub. Date: Nov. 28, 2002

(54) Adjustment of downlink transmission power in a telecommunications network such as a UMTS or other third generation network

(76) Inventors: Qiang Cao, Swindon (GB); Patrick Georges Venceslas Charriere, Tetbury (GB); Richard Llewelyn Davies, Corsham (GB)

Correspondence Address: Docket Administrator (Room 3J-219), Lucent Technologies Inc., 101 Crawfords Corner Road, Holmdel, NJ, 07733-3030, US

(21) Appl. No.: 10/123,381

(22) Filed: Apr. 16, 2002

(30) Foreign Application Priority Data
May 25, 2001 (EP) 01304652.9

(51) Int. Cl. H04B 7/00

(52) U.S. Cl. 455/522; 455/69

(57) ABSTRACT

A telecommunications network comprising a first unit and a second unit. The second unit measures the accuracy with which it receives data and transmits a value representing that accuracy to the first unit. The first unit adjusts its maximum transmission power to the second unit dependent upon said value.

### CROSS REFERENCE TO RELATED APPLICATION

This application claims priority of European Application No. 01304652.9 filed on May 25, 2001.

### BACKGROUND OF THE INVENTION

I. Field of the Invention

The present invention relates to a telecommunications network, a method of adjusting maximum transmission power, a base station, and a radio network controller.

II. Description of the Related Art

As is known from, for example 3^{rd} Generation Partnership Project Technical Specifications documents TS25.433, TS25.214 and TS25.331, in, for example, a Universal Mobile Telephone Service (UMTS) network there are requirements to control the power of signals sent downlink from base stations (Node B's) to subscriber units (user equipment UE's) so as to minimise interference between signals to subscribers who share common frequency bands.

There is a requirement for so-called outer loop power control (OLPC) discussed in the above mentioned standards. In essence this relates to the slower rate (or courser) downlink transmission power control i.e. control of maximum downlink transmission power as compared to the inner loop power control relating to faster rate and finer adjustment.

It is known to locate the downlink transmission power control block in the UMTS Terrestrial Radio Access Network (UTRAN), specifically in a Radio Network Controller (RNC) of the UTRAN. This allows the radio network controller to set the downlink transmission power based on predicting the signal to interference radios (SIR) which should be acceptable for downlink transmissions to various subscriber units (UE). However, there is relatively more signalling required across the radio link (Uu interface) between base station (Node B) and subscriber units (UE) also more processing must be done by the radio network controller (RNC) than otherwise.

A known alternative is to locate the control block downlink transmission power in the respective subscriber units (UE's) themselves. In known downlink outer loop power control, the UE compares the measured SIR (SIR-estimate) against the SIR-target. If the SIR-estimate is less than the SIR-target, the UE sends a transmission power control command (TPC) to require the base station (UTRAN) to increase its transmission power. In this known approach, subscriber units (UE) have total control over the downlink transmit power from the UTRAN. Although advantageously allowing effects which degrade the downlink signal to be taken into account when determining the SIR-target in the subscriber unit, in particular in its RAKE receiver, and requiring relatively less signalling traffic between base stations (Node B) and subscriber unit (UE), there is at least one significant disadvantage to this known approach.

It is that manufacturers of subscriber units may set stricter than necessary SIR-targets resulting in higher than strictly necessary downlink transmission power levels to be used. The result would be significant interference which would be unpredictable and could be high.

### SUMMARY OF THE INVENTION

The present invention provides a telecommunications network comprising a first unit and a second unit, the second unit comprising means operative to determine a value representative of the accuracy with which data is received from the first unit and to transmit said value to the first unit, the first unit being operative to adjust the maximum power with which the first unit sends data to the second unit dependent upon said value.

Preferably the first unit is a base station and the second unit is a subscriber unit, both operative to send data by radio, the maximum power which is adjusted being the maximum downlink power.

The present invention in its preferred embodiments solves the problem of subscriber units setting unnecessarily or unreasonably strict SIR targets resulting in unnecessarily or unreasonably high base station transmission powers and consequential interference problems.

Preferably the maximum downlink (DL) transmission power is not only set in initial Radio Link Setup stage, but is adjusted during the whole life cycle of a call to limit the base station UTRAN transmission power required by subcriber units UE.

Preferably the maximum downlink DL power is repeatedly adjusted during the whole life cycle of a call to limit the UTRAN transmission power required to transmit to the subscriber unit UE.

Preferably an information element (value) representing maximum downlink power for the UTRAN is used to dynamically adjust (i.e. adjust ‘on the fly’ i.e. during the call) downlink transmission power to a particular subscriber unit. This advantageously prevents a ‘selfish UE’ from requiring more than necessary transmission power by setting an unreasonable SIR-target irequiring higher than necessary downlink power in order to be satisfied. The UTRAN transmission power is a finite resource so a ‘selfish UE’if allowed to be selfish would request more power at the expense of other UE's.

The present invention also provides a method of adjusting maximum power in a call between a first unit and a second unit in a telecommunications network, comprising the steps of:

the second unit determining a value representative of the accuracy with which data is received from the first unit,

the second unit transmitting said value to the first unit,

the first unit adjusting the maximum power with which the first unit sends data to the second unit dependent upon said value.

The present invention also provides a base station comprising means operative to receive from a subscriber unit a value representative of the accuracy with which data sent downlink from the base station was received, the base station further comprising means operative to adjust the maximum downlink power for further downlink data transmissions dependent upon said value.

The present invention also provides a radio network controller (RNC) comprising comparator means operative to process a value representative of accuracy with which data was received by a subscriber unit by comparing said value to at least one threshold, and dependent upon the outcome of the or each comparison generating a control signal for adjusting maximum downlink transmission power of a transmitter/receiver station (Node B).

### BRIEF DESCRIPTION OF THE DRAWINGS

A preferred embodiment of the present invention will now be described, by way of example, and with reference to the Figures, in which:

FIG. 1 is a diagram illustrating the UMTS network,

FIG. 2 is a diagram illustrating the sequence of communication steps (denoted 1 to 10) in establishing a call and controlling downlink transmission power during the call, and FIG. 3 illustrates in more detail operation of the block in the (serving) radio network controller (SRN) controlling maximum downlink power, in other words it illustrates in more detail step 8 as shown in FIG. 2.

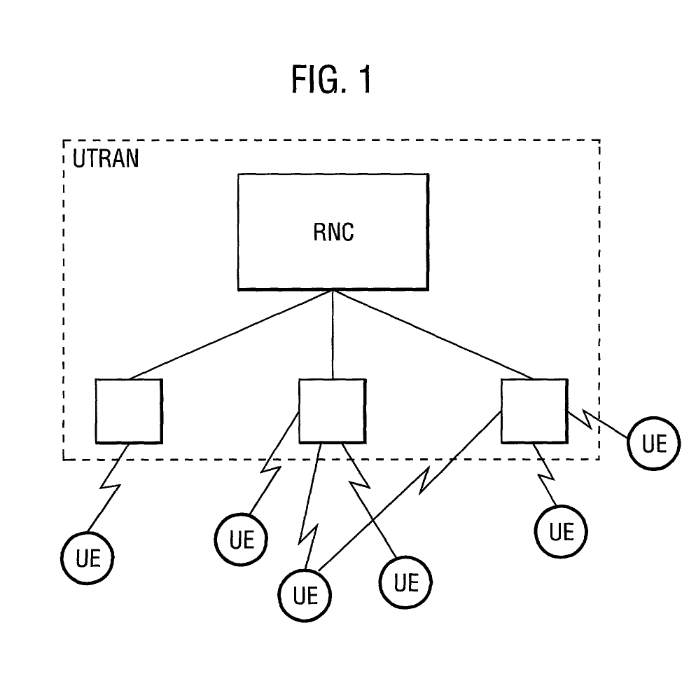

### DETAILED DESCRIPTION

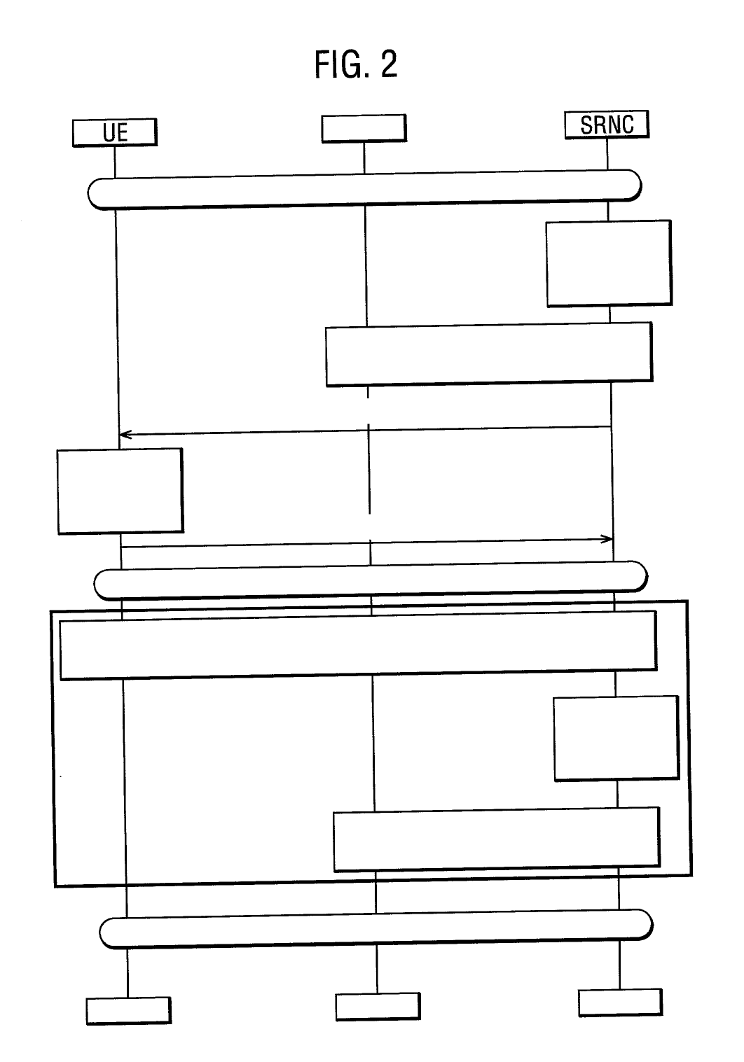

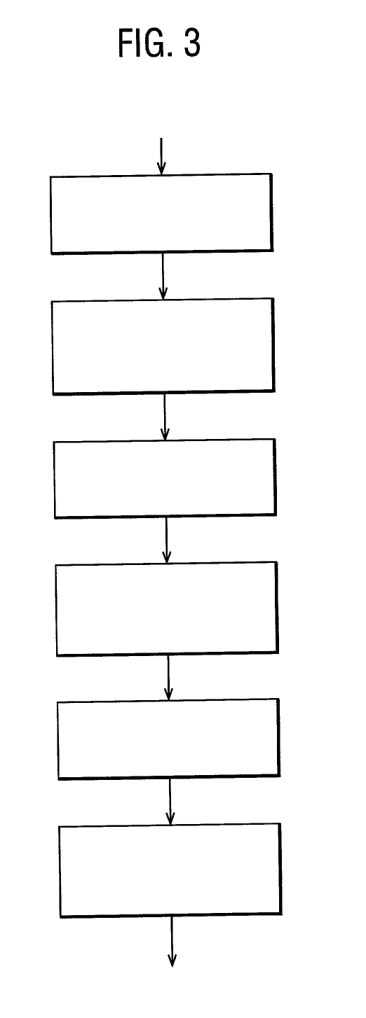

As shown in FIG. 2, the transmittter/receiver station (Node B), its controlling (serving) radio network controller (SRNC) and any particular subscriber unit (UE) with which a call is to be established operate as follows:

1. A radio resource control (RRC) connection having been set up on a dedicated control channel (DCCH), in other words, a signalling channel, a decision is made to create a radio bearer, i.e. set up a call.

2. The SRNC sends the value of the maximum downlink transmission power allowed for that call to the Node B. The allowed power value depends on the type of service (data, voice, video), and the type of subscriber unit so is service-and UE-specific.

3. As part of the radio bearer set up, a downlink reception quality target, namely a block error rate (BLER) target, is sent downlink to the UE on the dedicated channel (DCH) which is the channel dedicated to carry the call.

4. Based on the received BLER target (or received BLER targets for different types of service (voice, data,fax etc)) the signal interference ratio (SIR) required by the UE is determined. This depends on the construction of the UE. As required by the UMTS standard there is a BLER target required for each type of service (e.g., voice, fax, data, video) which can be handled.

5. The UE indicates via the Node B to the SRNC that call set up is complete.

6. User data is now transmitted.

Whilst user data is being transmitted (shown as step 6 and step 10 in FIG. 2), functions 7 to 9 as shown in FIG. 2 are operative as follows:

7. The UE periodically reports its BLER-estimate for each dedicated channel (DCH).

8. The UTRAN decides whether or not the downlink transmission power should be adjusted (e.g.down) by examining the reported BLER-estimate over a reasonable period of time.

9. If the UTRAN makes such a decision, the RNC will inform the Node B to adjust its maximum downlink transmission power by sending RADIO LINK RECONFIGURATION REQUEST including information element (IE) ‘Maximum DL power’ to be used for transmission to the particular subscriber unit.

Steps 7 to 9 occur repeatedly and automatically during the course of the call.

The maximum downlink power level is adjusted in steps, the size of which are set by the radio network controller (SRNC). A step is, for example, at least 0.1 dB when used in the range 35 dB to 15 dB to achieve a fast adjustment. (A minimum power step size is defined in the UMTS 3^{rd} Generation Partnership project standard as being 0.1 dB in that power range).

Downlink Transmission Power Adjustment

The functional stage 8 shown in FIG. 2 is shown in more detail in FIG. 3,and is as follows:

8.1 The radio network controller RNC extracts the information element IE ‘BLER-estimate’ (where BLER is block error rate) from the radio resource control RRC message ‘MEASUREMENT REPORT’ received from the subscriber unit. The RRC message is periodically reported from the UE to the RNC, reasonably frequently such that the RNC can make a judgement e.g. as to whether the subscriber unit's UE BLER implying that UTRAN transmission power is excessive.

8.2 The RNC compares the BLER-target set by the RNC and the BLER-estimate measured by the UE to assist the RNC in making a decision whether downlink power adjustment is required.Each type of call has an associated BLER target so as to ensure acceptable quality of service. Thus, for example, calls of the type carrying voice only payload data have different thresholds to those carrying, e.g. video.

8.3 The RNC decides if a ‘+’ or ‘−’ i.e. up or down adjustment is necessary. This is based on the comparison in the previous step 8.2. Note that in some embodiments whether adjustment is needed or not can be quite a complicated question in difficult radio environments. In these scenarios, the controlled adjustment can be used as precaution to prevent downlink transmission power from becoming excessive and/or reducing such power if it too became excessive.

8.4 The RNC decides the step (or slope) for the adjustment. The recursive algorithm is given as

P max(t)=P max(t−1)+s. Δ step

where P max (t) is the maximum downlink power level to the subscriber unit UE for time t, P max (t−1) is the maximum downlink power level to the subscriber unit UE for the previous time step (t−1) and s is a + or − sign function decided in section 8.3, and Δ step is power update step for changing maximum downlink transmission power. The value of Δ step is set depending on the following factors: frequency of the RRC message “MEASUREMENT REPORTING”, the BLER-estimate (a worse BLER-estimate requires or bigger adjustment step), accuracy of the adjustment, time delay of the adjustment, service type (e.g. voice, data, etc), service data rate, service combination (e.g. multimedia or single service type), and radio environment (multipath fading, and weather).

8.5 The RNC decides the new value of P max. This is done by calculation as mentioned in 8.4 above. P max is translated to the information element IE representing maximum DL transmission power.

8.6 The RNC constructs the message RADIO LINK RECONFIGURATION including the information element IE for max DL transmission power and sends it to the Node B to adjust the Node B maximum downlink transmission power.

1. A telecommunications network comprising a first unit and a second unit, the second unit comprising means operative to determine a value representative of the accuracy with which data is received from the first unit and to transmit said value to the first unit, the first unit being operative to adjust the maximum power with which the first unit sends data to the second unit dependent upon said value.

2. The telecommunications network of claim 1, in which the first unit is a base station and the second unit is a subscriber unit, both operative to send data by radio, the maximum power which is adjusted being the maximum downlink power.

3. The telecommunications network of claim 1, in which the value is a measure of Block Error rate (BLER).

4. The telecommunications network of claim 1, in which the maximum power (P max) is adjusted downwards dependent upon whether the value is below a predetermined threshold.

5. The telecommunications network of claim 1, in which the maximum power (P max) is adjusted upwards dependent upon whether the value is above a predetermined threshold.

6. The telecommunications network of claim 4, in which the threshold(s) are selected dependent upon the type of payload data carried in the call.

7. The telecommunications network of claim 1, in which the maximum power (P max) is adjusted by increasing or decreasing maximum power by a discrete step (A step) should adjustment be determined as being required.

8. The telecommunications network of claim 6, in which the maximum downlink power (P max) is adjusted according to the relation:
P max(t)=P max(t−1)+s. α step
where t is the current adjustment step in time, t−1 is the last adjustment step in time, s is + or − dependent on whether the maximum power is to be increased or decreased, and Δ step is the step change in maximum power to be applied.

9. The telecommunications network of claim 1, in which the steps of determining the value, transmitting the value to the first unit and adjusting the value are repeated during a call between the first unit and second unit.

10. The telecommunications network of claim 1, in which the network is a UMTS network or other third generation network.

11. The telecommunications network of claim 10, in which the first unit is a base station (UTRAN) comprises a radio network controller (RNC) and at least one transmitter/receiver station (Node B) under the control of the controller, the controller being operative to instruct the transmitter/receiver station(s) (Node B) to adjust maximum downlink transmission power dependent on said value(s).

12. The telecommunications network of claim 10, in which the maximum power which is adjusted is the outer loop maximum power.

13. A method of adjusting maximum downlink power in a call between a first unit and a second unit in a telecommunications network, comprising the steps of:
the second unit determining a value representative of the accuracy with which data is received from the first unit;
the second unit transmitting said value to the first unit; and
the first unit adjusting the maximum power with which the first unit sends data to the second unit dependent upon said value.

14. A base station comprising means operative to receive from a subscriber unit a value representative of the accuracy with which data sent downlink from the base station was received, the base station further comprising means operative to adjust the maximum downlink power for further downlink data transmissions dependent upon said value.

15. The base station of claim 14, further comprising a radio network controller (RNC) and at least one transmitter/receiver station (Node B) which operates under the control of the radio network controller, the radio network controller being operative to instruct the transmitter/receiver station(s) to adjust maximum downlink transmission power dependent upon said value(s) received.

16. A radio network controller (RNC) comprising comparator means operative to process a value representative of accuracy with which data was received by a subscriber unit by comparing said value to at least one threshold, and dependent upon the outcome of the or each comparison generating a control signal for adjusting maximum downlink transmission power of a transmitter/receiver station (Node B).
